(19) United States
(12) Patent Application Publication
(10) Pub. No.: US 2006/0048716 A1
(43) Pub. Date: Mar. 9, 2006

(54) Animal carriage

(76) Inventor: Diane L. Garofola, Greensburg, PA (US)

Correspondence Address: R.J. THOMAS MFG. CO. INC., PO BOX 946, 5648 HWY 59 SOUTH, CHEROKEE, IA, 51012-0946, US

(21) Appl. No.: 10/936,300

(22) Filed: Sep. 8, 2004

(51) Int. Cl. A01K 31/07

(52) U.S. Cl. 119/453

(57) ABSTRACT

An animal carriage used for air, land, and sea transportation purposes comprises a separate wheeled platform, an animal container box with an optional cover, a detachably connected push-bar, a leash restraint system, and a sized animal harness system.

### BACKGROUND OF THE INVENTION

1. Field of the Invention

The present invention relates generally to a device for transportation of animals and, more particularly, a carriage for transporting animals by pedestrian means or alternatively, in automobiles, boats, or airplanes. The present invention is also directed to a method of securing an animal in an animal carriage for transportation purposes.

2. Description of Related Art

Large lines of strollers are available for use with children but are not compatible for animal use for reasons including body shape and size. Animal transportation devices, to be most versatile, must be adaptable to land, sea, and air travel, while additionally being suitable for pedestrian walks. It is difficult to create one animal transportation device to adapt to all variations of these transportation means.

Several approaches have been investigated by inventors to create suitable devices for animal transportation. Devices have been marketed by Pets Alley Dog Supplies for air travel accommodating the Federal Aviation Association standards, however, these are narrowly limited to airline travel due to the small size of the wheels and semi-rigid construction, preventing useful upright pedestrian service. Additionally, these products do not have provisions to accommodate seat belt restraints required for automotive travel. Another variation of rolling luggage for pets marketed by Skymall, Inc. fails to include the safety restraint system and a cover for an animal's optimal comfort while traveling.

The present invention solves the problem of multiple transportation needs by teaching the means and method for providing an animal carriage suitable for pedestrian walks, yet is adaptable to automobile, ship, and airline travel, including an animal restraining system, and a removable animal container box with an optional snap-on cover.

### SUMMARY OF THE INVENTION

Briefly, it is an object of the present invention to provide an animal carriage suitable for pedestrian walks, yet, adaptable for automotive, ship, and airline travel. A carriage is provided containing an integral push bar with an animal restraint system detachably connected to a wheeled platform. The carriage contains an animal container, which is removable from the wheeled platform. The animal container may be sized to fit on an automobile seat, retained in position by the automobile's seat belt restraint system. The animal container may be sized to fit below an airplane passenger seat when the integral push bar is detached. The wheeled platform and push bar may be sized to fit within an overhead compartment on an aircraft. The attached wheels of the wheeled platform are between 2.5 and 6 inches for optimal performance. A detachable cover is an option to fully enclose the animal carriage. The animal restraint systems may be variously sized.

These, as well as other attributes of the present invention, will become more readily apparent when reference is made to the accompanying drawings taken with this detailed description.

### BRIEF DESCRIPTION OF THE DRAWINGS

FIG. 1 is a schematic view of the animal carriage wheeled platform;

FIG. 2 is a schematic view of the animal carriage container box;

FIG. 3 is a schematic view of the animal carriage push bar and restraint system; and

FIG. 4 is a schematic view of the animal carriage according to a preferred embodiment of the present invention.

### DETAILED DESCRIPTION OF THE INVENTION

Briefly stated, the present invention is directed towards transportation of animals via air, land, or sea.

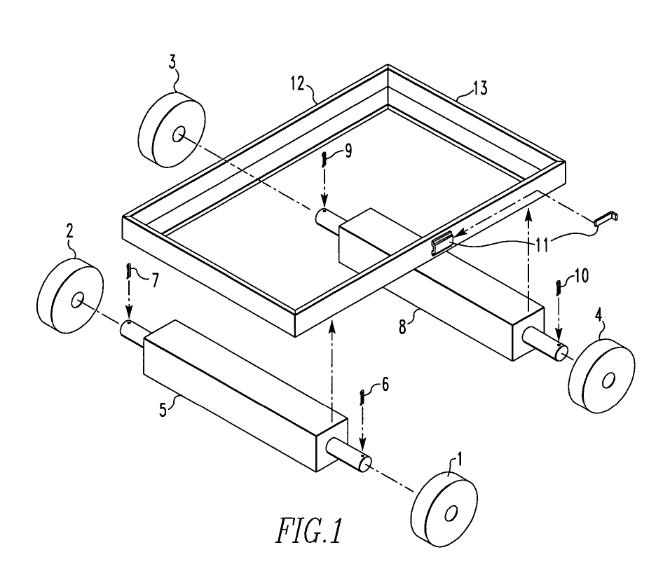

One preferred embodiment of the present invention is depicted in FIGS. 1-4 illustrating the animal carriage comprising five main components: a separate wheeled platform, an animal container box, a push-bar, a leash restraint system, and a sized animal harness system. When the animal carriage is used to take pets for a walk, the wheeled platform, the animal container box, the push bar, and leash restraint system components are required and the animal harness system component is optional. When the animal carriage is used to take animals for a ride in an automobile, the animal container box, the push-bar, the leash restraint system, and the sized animal harness system components are required while the wheeled platform component is removed and can be stored in the automobile. The automobile restraint system is placed over the push-bar and the animal container box assuring that the animal will be protected in the event of a sudden stop. When the animal carriage is used to transport animals in an airplane, only the animal container box component is required with an optional top cover. All other components to the animal carriage can be stowed in overhead bins of the aircraft or checked in as luggage.

The components of the wheeled platform are shown in FIG. 1 comprising four wheels 1, 2, 3, and 4. Wheels 1 and 2 are free to rotate about axle 5 and held in place by pins 6 and 7. Similarly, wheels 3 and 4 are free to rotate about axle 8 and held in place by pins 9 and 10. Locking slide pin assembly 11 and a second locking slide pin assembly (not shown) are placed on the center of the opposite frame rails 12 of the frame assembly 13.

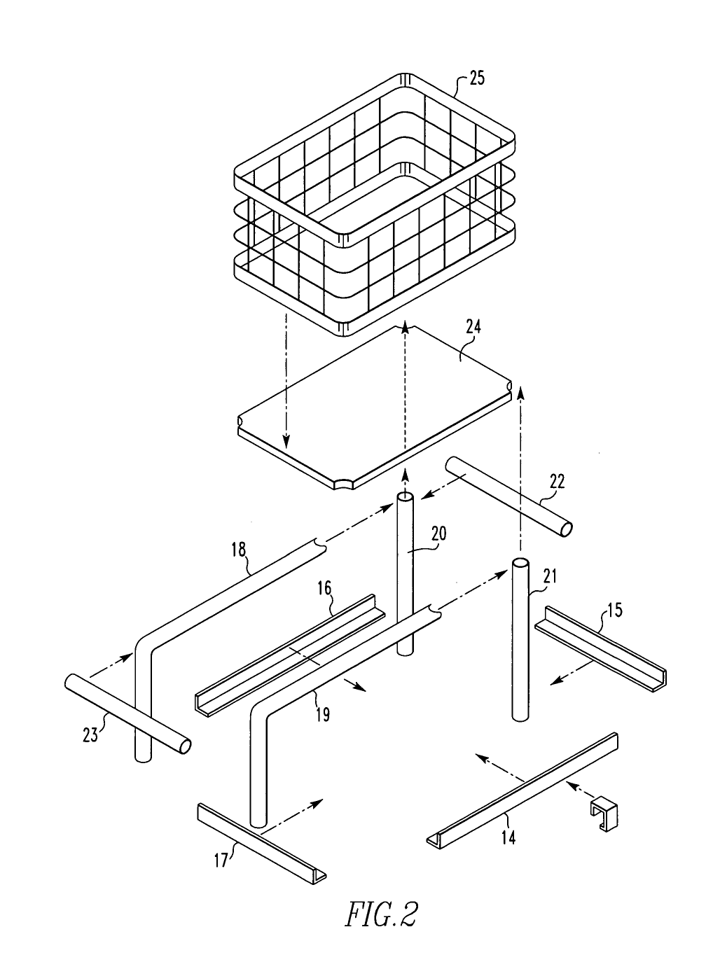

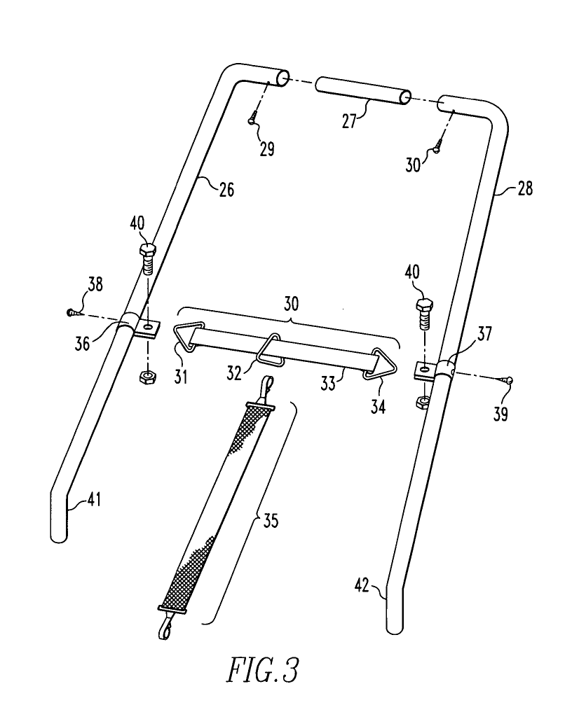

The components of the animal carriage are shown in FIG. 2. Outside frame members 14, 15, 16, and 17 are placed as shown with the base leg of each member pointing inward, then bolted, fastened, or welded into a rectangular shape with all included angles equal to 90 degrees. Dimensional control of the components is such that, after bolting, fastening, or welding has been completed and any burrs removed, the completed frame will fit snugly inside wheeled platform 13. Side rail 18 is bolted, fastened, or welded into the corner of frame members 16 and 17. The long end of side rail 18 is bolted, fastened, or welded to the top of upright tube 20 after upright tube 20 has been bolted, fastened, or welded to the inside corner and bottom faces of frame members 15 and 16. Similarly, side rail 19 is bolted, fastened, or welded into the corner of frame members 14 and 15. The long end of side rail 19 is bolted, fastened, or welded to the top of upright tube 21 after upright tube 21 has been bolted, fastened, or welded to the inside corner and bottom faces of frame members 14 and 15. At first, spacer tube 22 is bolted, fastened, or welded to the top inward facing short sides of rails 18 and 19 and a second spacer tube 23 is bolted, fastened, or welded to the rails 18 and 19 opposite first spacer tube 22. Floor piece 24 is placed, without any fasteners, into frame assembly 25. The bottom face of floor piece 24 is covered with a non-skid surface type of material (not shown), such as CleanGrip™ 2000 from Michelman, Inc. This type of surface helps to maintain the pet carrier in place when placed on the seat of an automobile or airplane. The top surface of floor piece 24 is covered with a washable outdoor carpet (not shown), such as DuPont XtraLife™, to provide comfort for the animal passenger. Open mesh tube sleeve 25 is sized to fit snugly over the rails 18 and 19 and upright tubes 20 and 21. The components of the push-bar with restraint system are shown in FIG. 3. Left side push-bar rail 26 is placed over insert tube 27 which fits snugly inside of push-bar rail 26 and right side push-bar rail 28. After assembly of side push-bar rails 26, 28, and insert tube 27, set screws 29 and 30 are tightened to provide a locking action of said components. The restraint system components consist of a web assembly 30 with D-ring 31 attached to the left side of webbing 33; a freely sliding D-ring 32 and D-ring 34 attached to the right side of webbing 33; joining a web assembly with two swivel snap hooks 35. D-ring 31 is attached to clamp 36, and D-ring 34 is attached to clamp 37. The position of clamps 36 and 37 is maintained by set screws 38 and 39. The connection between D-rings and clamps is accomplished using bolt and nut assemblies 40.

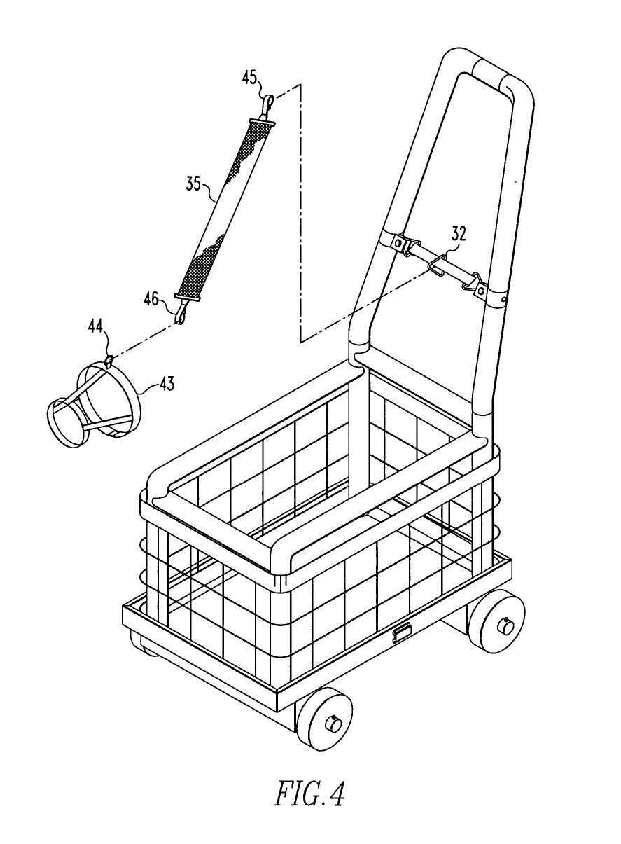

The complete assembly is shown in FIG. 4. Assembled components of the wheeled platform as shown in FIG. 1 are joined with assembled components of the animal carriage container box as shown in FIG. 2, joining assembled components of the push-bar as shown in FIG. 3, wherein ends 41 and 42 of the push bar assembly shown in FIG. 3 slip into upright tubes 20 and 21 shown in FIG. 2 of the animal carriage container box. The web assembly 35 with two swivel snap hooks 45, 46 is shown out of final position; swivel end hook 45 will attach to sliding D-ring 32, and swivel end hook 46 will attach to the pet harness 43 at connection ring 44.

Having thus described my invention with the detail and particularity required by the Patent Laws, what is desired protected by Letters Patent is set forth in the following claims.

1. An animal carriage for transporting an animal, comprising:
a platform including a plurality of wheels;
a container having a bottom, a front, opposed rear side, and a pair of opposed sides, all extending from said bottom, said container removably attached to said platform; and
a push-bar directly mounted to said container;
wherein said push-bar is not directly mounted to said wheeled platform.

2. The animal carriage of claim 1, wherein said wheels have locks to prevent rotation in all axes.

3. The animal carriage of claim 1, wherein said wheels have a diameter greater than 2.5 inches but less than or equal to 6 inches.

4. (canceled)

5. The animal carriage of claim 1, further comprising an animal-restraint harness lockably attached to said container.

6. The animal carriage of claim 1, wherein the animal-restraint harness is adjustable.

7. The animal carriage of claim 1, wherein the container has mesh sides.

8. The animal carriage of claim 1, wherein the container has a non-slip surface applied to an underside of said bottom.

9. The animal carriage of claim 1, wherein the container has a carpet on a top surface of said bottom.

10. The animal carriage of claim 9, wherein the carpet is washable.

11. The animal carriage of claim 1, wherein the container has a cover.

12. The animal carriage of claim 10, wherein the container has a detachable cover.

13. A method of transporting an animal using an animal carriage comprising the steps of:
(a) transporting an animal in the animal carriage via pedestrian movement, the animal carriage comprising,
(i) a container,
(ii) a platform including a plurality of wheels, said platform removably attached to said container, and
(iii) a push-bar directly mounted to said container,
wherein said transporting of the animal includes wheeled movement of the carriage resulting from pushing of the push-bar;
(b) preparing for transport of the animal via non pedestrian movement by
(i) detaching said container from said wheeled platform, and
(ii) detaching said push-bar from said container.
wherein said steps (b)(i) and (b)(ii) are distinct and are performed independent of the othcr.

14. The method of claim 13, further comprising restraining the animal using said animal-restraint system.

15. The method of claim 13, further comprising securing the container in a transportation device.

16. The method of claim 15, further comprising restraining the container within an automobile by:
detachably joining the automobile integral belt restraint system to the container.

17. The method of claim 15, further comprising means restraining the container within an airplane by:
sliding the container under said airplane seat.

18. The method of claim 13, wherein said steps (b)(i) and (b)(ii) are performed while the animal is disposed within the container.

19. An animal carriage for transporting of an animal comprising:
(a) a pet carrier including a container for the animal;
(b) a plurality of wheels that are selectively attached to said container through a plurality of components; and
(c) a substantially rigid handle that is mounted directly to said container and that is adapted to extend from said container to a height for pushing ad pulling of said container when said plurality of wheels are selectively attached to said container.

20. The animal carriage of chains 19, wherein the plurality of components comprises,
(i) first and second axles;
(ii) four pins; and
(iii) a platform that is removably attached to said container such that said container and the platform may be selectively separated and joined.

21. A method of transporting an animal by pedestrian movement and non pedestrian movement using the animal carriage of claim 19.
